(19) United States
(12) Patent Application Publication
(10) Pub. No.: US 2016/0242465 A1
(43) Pub. Date: Aug. 25, 2016

(54) An Igniting Activator for Novel Electric-Heating Cigarette

(71) Applicant: CHINA TOBACCO YUNNAN INDUSTRAIAL CO., LTD, Kunming, Yunnan (CN)

(72) Inventors: Xudong ZHENG, Kunming (CN); Jianguo TANG, Kunming (CN); Dalin YUAN, Kunming (CN); Ping LEI, Kunming (CN); Shanzhai SHANG, Kunming (CN); Shoubo LI, Kunming (CN); Yongkuan CHEN, Kunming (CN); Mingming MIAO, Kunming (CN)

(21) Appl. No.: 14/761,250

(22) PCT Filed: Nov. 10, 2014
(86) PCT No.: PCT/CN2014/090718

§ 371 Date: Jul. 15, 2015

(30) Foreign Application Priority Data
Jul. 18, 2014 (CN) 201410344957.8

(51) Int. Cl. A24F 47/00; H05B 3/00

(52) U.S. Cl. CPC A24F 47/008; H05B 3/0014

(57) ABSTRACT

This invention relates to an electric-heating smoking article comprising an igniting activator, the electric-heating smoking article comprising a mouthpiece 20 on its one end, and the igniting activator 10 on its other end, wherein the igniting activator 10 comprises at least one temperature measurement element 1 and a heat conductor 2 contacting with the temperature measurement element 1, wherein the temperature measurement element 1 is connected to a positive wire terminal of a heating element 5 and a negative wire terminal of a power supply 6. When the heat conductor 2 is heated to a temperature above a specified value, the smoking article activates the heating element to heat, enabling consumers to get used to novel electric-heating cigarettes without changing their traditional smoke behaviors while keeping the igniting manner unchanged. This invention also discloses an igniting activation method of an electric-heating smoking article.

### CROSS-REFERENCE TO RELATED APPLICATIONS

This application is a 371 of PCT/CN2014/090718 filed Nov. 10, 2014 which claims benefit of CN 201410344957.8 filed on Jul. 18, 2014, both of which are incorporated herein by reference in their entireties.

### FIELD OF THE INVENTION

This invention relates to the field of a smoking article for novel electric-heating cigarettes.

### BACKGROUND OF THE INVENTION

Nowadays, the risk of cigarettes has attracted more and more concerns. Faced with a serious challenge in the situation of smoking control, with the difficulty in further tar reduction of traditional tobacco products, as an evolution and supplement of traditional cigarettes, there is a necessity to develop new kinds of tobacco products, leading to the emergence of many related study efforts. Novel electric-heating cigarettes characterized by a heating temperature less than 500° C., smoke generation by means of heating rather than combustion, and less hazard components cracked from tobacco at high temperature while satisfying the sensory needs of consumers are gradually becoming a hotspot studied by various tobacco enterprises.

Due to the habit of lighting cigarettes with lighters formed by consumers through their long term of smoking behaviors, when smoking novel cigarettes, they may instinctively light up with lighters, so that smokers who newly use the electric-heating cigarettes tend to damage their electric-heating smoking article by regular lighting actions. Most current electric-heating smoking articles are activated by buttons, which is in nature different from that used for traditional cigarettes. Thus, consumers have to change their traditional smoking habit to adapt themselves to the novel electric-heating cigarettes. However, as a habit of lighting up with lighters formed by consumers smoking traditional cigarettes for a long time, it is a subconscious smoking behavior formed unconsciously, and is relatively harder to be changed in an unnatural manner.

In view of the above issues, an electric-heating article comprising an igniting activator for novel electric-heating cigarettes is provided in this invention, which retains the same igniting manner as lighters, enabling consumers to get used to novel electric-heating cigarettes without changing the traditional smoking behavior.

### BRIEF DESCRIPTION OF THE DRAWINGS

FIG. 1 is a schematic diagram of the general structure of an electric-heating smoking article comprising an igniting activator according to this invention.

FIG. 2 is a schematic diagram of the structure of the igniting activator 10 of this invention.

Reference numbers: temperature measurement element 1, heat conductor 2, light emitter 3 transparent member 4, positive wire terminal of heating element 5, negative wire terminal of power supply 6; positive wire terminal of light emitter 7, igniting activator 10, mouthpiece 20, battery 30, circuit board 40, tobacco cavity 50, electric-heating element 60.

### SUMMARY OF THE INVENTION

The object of this invention is to change the activation of the smoking article of novel electric-heating cigarettes and provide an igniting apparatus activated by a lighter. The object of this invention is realized by the following technical solutions:

On a first aspect of this invention, this invention relates to an electric-heating smoking article comprising an igniting activator 10 provided on one end of the electric-heating smoking article, and a mouthpiece 20 provided on the other end of the electric-heating smoking article, wherein the igniting activator 10 comprises at least one temperature measurement element 1 and a heat conductor 2 contacting with the temperature measurement element 1, wherein the temperature measurement element 1 is connected to a positive wire terminal of heating element 5 and to a negative wire terminal of power supply 6.

In a preferred embodiment, the igniting activator 10 further comprises a light emitter 3 and a transparent member 4 surrounding the light emitter 3, wherein the light emitter 3 is connected to a positive wire terminal of the light emitter 7 and the negative wire terminal of power supply 6, wherein the transparent member 4 is closer to the mouthpiece than the heat conductor 2.

In a preferred embodiment, wherein the temperature measurement element 1 is a thermocouple or a thermal resistor; independently, the light emitter 3 is a Light Emitting Diode (LED); independently, the heat conductor is a metal material having a thermal conductivity of above 30 W/mK; independently, the transparent member 4 is made of a heat insulating material.

In a preferred embodiment, the electric-heating smoking article of this invention comprises a battery 30, a circuit board 40, a tobacco cavity 50, an electric-heating element 60, wherein the tobacco cavity 50 is located between the mouthpiece 20 and the igniting activator 10, the electric-heating element 60 is provided in or surrounding the tobacco cavity, and the battery 30 and the circuit board 40 are located at other positions in the electric-heating smoking article.

As a second aspect of this invention, this invention relates to an igniting activation method of an electric-heating smoking article, wherein a mouthpiece 20 is provided on one end of the electric-heating smoking article and an igniting activator 10 is provided on the other end of the electric-heating smoking article, wherein the igniting activator 10 comprises at least one temperature measurement element 1 and a heat conductor 2 contacting with the temperature measurement element 1, wherein the temperature measurement element 1 is connected to a positive wire terminal of heating element 5 and to a negative wire terminal of power supply 6; when the heat conductor 2 is heated by a lighter flame, flame heat is absorbed by the heat conductor 2 and is transferred to the temperature measurement element 1; when the temperature measurement element 1 detects a temperature value equal to or higher than a predetermined threshold value, a loop is closed between the positive wire terminal of heating element 5 and the negative wire terminal of power supply 6, so that the heating element begins to heat.

As a third aspect of this invention, this invention relates to an igniting activation method of an electric-heating smoking article, wherein a mouthpiece 20 is provided on one end of the electric-heating smoking article and an igniting activator 10 is provided on the other end of the electric-heating smoking article, wherein the igniting activator 10 comprises at least one temperature measurement element 1 and a heat conductor 2 contacting with the temperature measurement element 1, wherein the temperature measurement element 1 is connected to a positive wire terminal of heating element 5 and to a negative wire terminal of power supply 6; the igniting activator further comprises a light emitter 3 and a transparent member 4 surrounding the light emitter 3, wherein the light emitter 3 is connected to a positive wire terminal of the light emitter 7 and to the negative wire terminal of power supply 6, when the heat conductor 2 is heated by a lighter flame, flame heat is absorbed by the heat conductor 2 and is transferred to the temperature measurement element 1; when the temperature measurement element 1 detects a temperature value equal to or higher than a predetermined threshold value, a loop is closed between the positive wire terminal of heating element 5 and the negative wire terminal of power supply 6, so that the heating element begins to heat, meanwhile, the light emitter 3 begins to emit light to indicate the success of ignition.

In the preferred embodiments according to the second and third aspects, wherein the temperature measurement element 1 is a thermocouple or a thermal resistor; independently, the light emitter 3 is a Light Emitting Diode (LED); independently, the heat conductor is a metal material having a thermal conductivity of above 30 W/mK; independently, the transparent member 4 is made of a heat insulating material.

With the electric-heating smoking article comprising an igniting activator and the igniting activation method of this invention, the igniting process of the electric-heating cigarette is similar to the process of lighting a traditional cigarette with a lighter, which may totally fit with the behavior habit of smokers of traditional cigarettes. Thus, this invention has advantages of: with the temperature detection element, detecting the temperature of the heat conductor heated by a lighter, so as to control the activation of the heating element and enable consumers to get used to novel electric-heating cigarettes without changing their traditional smoke behaviors while keeping the igniting manner unchanged.

### DETAILED DESCRIPTION OF THE PREFERRED EMBODIMENT

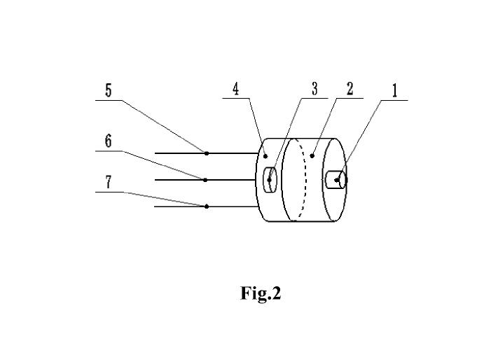

FIG. 2 shows a schematic diagram of the structure of the igniting activator for novel electric-heating cigarettes according to this invention. The igniting activator comprises a temperature measurement element 1, a heat conductor 2, a light emitter 3, a transparent member 4, a positive wire terminal of heating element 5, a negative wire terminal of power supply 6, and a positive wire terminal of the light emitter 7.

The heat conductor 2 is made of a material having a higher heat conductivity, such as Ag, Cu, Au, Al and other metal materials, which can absorb flame heat of a lighter in 2 seconds and raise its temperature to 50˜100° C. A hole is provided at the center of the heat conductor to accommodate the temperature measurement element 1. The temperature measurement element 1 may be a thermocouple, a thermal resistor or other digital temperature measurement element, preferably, a temperature sensor DS18B20. When the temperature measurement element 1 detects that the temperature of the heat conductor has raised to 50˜100° C., preferably, 65˜85° C., a control circuit outputs a control signal. As a result, the positive wire terminal of heating element 5 is closed and a heating process of the heating element starts accordingly.

The light emitter 3 is used to indicate whether the system is activated successfully, and may be a single color or bicolor LED, emitting red, blue, green, yellow, orange or purple light, and preferably, a red light LED. The light emitter 3 is provided inside the transparent member 4. When the temperature measurement element detects a temperature reaching to a specified value, the positive wire terminal of light emitter 7 is closed and the light emitter begins to light, indicating the success of ignition.

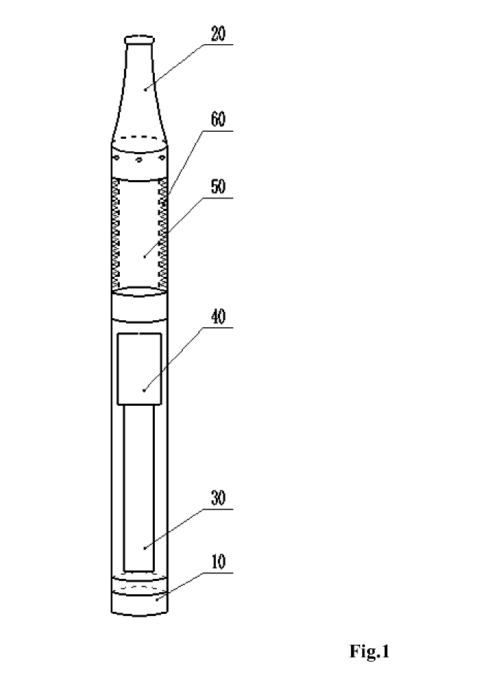

As shown in FIG. 1, the electric-heating smoking article comprises on its one end the igniting activator 10 described above, and a mouthpiece 20 on the other end thereof. Further, it also comprises a battery 30, a circuit board 40, a tobacco cavity 50, an electric-heating element 60, wherein the tobacco cavity 50 is located between the mouthpiece 20 and the igniting activator 10 for accommodating a tobacco product. The heating element is provided in or surrounding the tobacco cavity. The battery 30 and the circuit board 40 are located at other positions in the electric-heating smoking article. The battery, the circuit board and the igniting activator are electrically connected with each other in such a form that the object of this invention may be realized, and may be arranged by those skilled in the art according to particular situations.

1. An electric-heating smoking article comprising an igniting activator, the electric-heating smoking article comprising a mouthpiece (20) on its one end, and the igniting activator (10) on its other end, wherein the igniting activator (10) comprises at least one temperature measurement element (1) and a heat conductor (2) contacting with the temperature measurement element (1), wherein the temperature measurement element (1) is connected to a positive wire terminal of a heating element (5) and to a negative wire terminal of an power supply (6).

2. The electric-heating smoking article according to claim 1, wherein the igniting activator (10) further comprises a light emitter (3) and a transparent member (4) surrounding the light emitter (3), wherein the light emitter (3) is connected to a positive wire terminal of the light emitter (7) and to the negative wire terminal (6) of an power supply, wherein the transparent member (4) is closer to the mouthpiece than the heat conductor (2).

3. The electric-heating smoking article according to claim 1, wherein the temperature measurement element (1) is a thermocouple or a thermal resistor; independently, the light emitter (3) is a Light Emitting Diode (LED); independently, the heat conductor is a metal material having a thermal conductivity above 30 W/mK; independently, the transparent member (4) is made of a heat insulating material.

4. The electric-heating smoking article according to claim 1, further comprising a battery (30), a circuit board (40), a tobacco cavity (50), an electric-heating element (60), wherein the tobacco cavity (50) is located between the mouthpiece (20) and the igniting activator (10), the electric-heating element (60) is provided in or surrounding the tobacco cavity, and the battery (30) and the circuit board (40) are located at other positions in the electric-heating smoking article.

5. An igniting activation method of an electric-heating smoking article, wherein the electric-heating smoking article comprises a mouthpiece (20) on its one end, and the igniting activator (10) on its other end, wherein the igniting activator (10) comprises at least one temperature measurement element (1) and a heat conductor (2) contacting with the temperature measurement element (1), wherein the temperature measurement element (1) is connected to a positive wire terminal of a heating element (5) and to a negative wire terminal of an power supply (6) ; when the heat conductor (2) is heated by a lighter flame, flame heat is absorbed by the heat conductor (2) and is transferred to the temperature measurement element (1); when the temperature measurement element (1) detects a temperature value equal to or higher than a predetermined threshold value, a loop is closed between the positive wire terminal of a heating element (5) and the negative wire terminal (6) of an power supply, so that the heating element begins to heat.

6. An igniting activation method of an electric-heating smoking article, wherein the electric-heating smoking article comprises a mouthpiece (20) on its one end, and the igniting activator (10) on its other end, wherein the igniting activator (10) comprises at least one temperature measurement element (1) and a heat conductor (2) contacting with the temperature measurement element (1), wherein the temperature measurement element (1) is connected to a positive wire terminal of a heating element (5) and a negative wire terminal of an power supply (6); the igniting activator further comprises a light emitter (3) and a transparent member (4) surrounding the light emitter (3), wherein the light emitter (3) is connected to a positive wire terminal of the light emitter (7) and to the negative wire terminal (6) of an power supply , when the heat conductor (2) is heated by a lighter flame, flame heat is absorbed by the heat conductor (2) and is transferred to the temperature measurement element (1); when the temperature measurement element (1) detects a temperature value equal to or higher than a predetermined threshold value, a loop is closed between the positive wire terminal of a heating element (5) and the negative wire terminal (6) of an power supply , so that the heating element begins to heat, meanwhile, the light emitter (3) begins to emit light to indicate the success of ignition.

7. The igniting activation method according to claim 5, wherein the temperature measurement element (1) is a thermocouple or a thermal resistor; independently, the light emitter (3) is a Light Emitting Diode (LED); independently, the heat conductor is a metal material having a thermal conductivity above 30 W/mK; independently, the transparent member (4) is made of a heat insulating material.
